(19) United States
(12) Patent Application Publication
(10) Pub. No.: US 2010/0110886 A1
(43) Pub. Date: May 6, 2010

(54) Automated local spectrum usage awareness

(75) Inventors: Antti S. Sorri, Helsinki (FI); Jari Petteri Lunden, Espoo (FI); Elena Virtej, Espoo (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/291,071

(22) Filed: Nov. 5, 2008

(51) Int. Cl. H04L 12/24; H04L 12/26

(52) U.S. Cl. 370/229; 370/241

(57) ABSTRACT

Disclosed herein are methods, apparatus and computer programs providing localized awareness of spectrum usage and other factors in uncoordinated deployments of radio access networks. A method includes transmitting a beacon from a first access node for reception by a first user terminal that is associated with the first access node and also by a second user terminal that is associated with a second access node. The method further includes receiving feedback from the first user terminal that is associated with the first access node, the feedback comprising information obtained by the first user terminal from a beacon received from the second access node.

### TECHNICAL FIELD

The exemplary and non-limiting embodiments of this invention relate generally to wireless communication systems, methods, devices and computer programs and, more specifically, relate to wireless communication system that use uncoordinated spectrum deployments possibly in combination with flexible spectrum usage.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project
ADSL asymmetric digital subscriber line
AP access point (base station)
BS base station
BW bandwidth
DL downlink (AP towards UT)
eNB EUTRAN Node B (evolved Node B)
EPC evolved packet core
EUTRAN evolved UTRAN (LTE)
FSU flexible spectrum use
LTE long term evolution
MAC medium access control
MM/MME mobility management/mobility management entity
MS mobile station
OFDMA orthogonal frequency division multiple access
PDCP packet data convergence protocol
PDU protocol data unit
PHY physical
RLC radio link control
RRC radio resource control
SGW serving gateway
TDD time division duplex
UE user equipment
UT user terminal
UL uplink (UT towards AP)
UTRAN universal terrestrial radio access network

The specification of a communication system known as evolved UTRAN (EUTRAN, also referred to as UTRAN LTE or as EUTRA) is currently nearing completion within the 3GPP. As specified the DL access technique is OFDMA, and the UL access technique is SC-FDMA (single carrier, frequency division multiple access).

One specification of interest in this regard is 3GPP TS 36.300, V8.5.0 (2008-05), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), which is incorporated by reference herein in its entirety. This system may be referred to for convenience as LTE Rel-8, or simply as Rel-8. Note that this is a stage 2 specification, and may not exactly describe the system as it is currently expected to be implemented. In general, the set of specifications given generally as 3GPP TS 36.xyz (e.g., 36.211, 36.311, 36.312, etc.) may be seen as describing the entire Release 8 LTE system.

Of particular interest herein are the further releases of 3GPP LTE targeted towards future IMT-A systems, referred to herein for convenience simply as LTE-Advanced (LTE-A). Of additional interest herein are local area (LA) deployment scenarios using a scalable bandwidth (of up to, for example, 100 MHz) with flexible spectrum use (FSU). This system concept may be referred to herein for convenience as LTE-A.

Reference can also be made to 3GPP TR 36.913, V8.0.0 (2008-06), 3rd Generation Partnership Project; Technical Specification Group Radio Access Network; Requirements for Further Advancements for E-UTRA (LTE-Advanced) (Release 8), incorporated by reference herein in its entirety.

As cell sizes become smaller and data rates increase, the limited availability of spectrum drives wireless systems to use higher center frequencies. The use of smaller cells makes it more difficult to provide outdoor to indoor coverage transitions, and it also tends to increase the number of access points. It can be expected that a need will arise to handle deployments of a much larger number of access points, in particular in locations with restricted access (such as homes and offices).

This development has lead to a need to standardize small access points for cellular systems, sometimes referred to as “pico” or “femto” access points (e.g., having uncoordinated coverage distances measured in, for example, meters or tens of meters), in order to support high data rates in small areas. Such system architectures can be contrasted to current (coordinated deployment) cellular systems, and are typically based on privately owned and installed uncoordinated deployments. Such uncoordinated deployments are likely to consist of separate, overlapping networks, creating a demand for an approach that enables more than one network to co-exist in the same frequency band.

The use of FSU for future wireless systems is intended to provide spectrum sharing between the parties that participate actively in the communication process. A goal is to utilize the spectrum in an as optimal a manner as possible in order to achieve a high use flexibility of the radio resources.

In uncoordinated deployments there is no overall control over the placement of access points, nor is there any expectation of frequency planning or any other traditional network planning methods. As a result, the transmissions of neighboring access points may cause severe interference, even though there would be unused radio resources available. One result is a degradation of overall system capacity.

In LTE radio resource management is arranged within a single network and utilizes the X2 interface between base stations (eNBs). Reference in this regard may be made to FIG. 1, which reproduces FIG. 4.1 of 3GPP TS 36.300, and shows the overall architecture of the EUTRAN (LTE) system. The EUTRAN system includes eNBs that provide the EUTRA user plane (PDCP/RLC/MAC/PHY) and control plane (RRC) protocol terminations towards the UE. The eNBs are interconnected with each other by means of the above-mentioned X2 interface. The eNBs are also connected by means of an S1 interface to an EPC, more specifically to a MME (Mobility Management Entity) by means of a S1 MME interface and to a Serving Gateway (SGW) by means of a S1 interface. The S1 interface supports a many to many relationship between MMEs/Serving Gateways and eNBs.

However, the inter-access point interface does not exist when cells belong to different networks, or are based on an ADSL backbone (femto BS).

FSU utilizing over the air communication between BSs has been previously considered. For example, reference can be made to IST-4-027756 WINNER II, D6.13.14, version 1.1, WINNER II System Concept Description, G. Auer et al. Jan. 18, 2008. However, this approach presents at least one problem in that a communication channel between BSs does not necessarily exist, even though a neighboring BS may be interfering with terminals of the BS.

### SUMMARY

The foregoing and other problems are overcome, and other advantages are realized, by the use of the exemplary embodiments of this invention.

A first aspect of the exemplary embodiments of this invention provides a method that comprises transmitting a beacon from a first access node for reception by a first user terminal that is associated with the first access node and also by a second user terminal that is associated with a second access node; and receiving feedback from the first user terminal that is associated with the first access node, the feedback comprising information obtained by the first user terminal from a beacon received from the second access node.

Another aspect of the exemplary embodiments of this invention provides a computer-readable memory medium that stores program instructions, the execution of which result in performing operations that comprise transmitting a beacon from a first access node for reception by a first user terminal that is associated with the first access node and also by a second user terminal that is associated with a second access node; and receiving feedback from the first user terminal that is associated with the first access node, the feedback comprising information obtained by the first user terminal from a beacon received from the second access node.

Another aspect of the exemplary embodiments of this invention provides an apparatus that comprises a controller configured to operate with a wireless transmitter and a wireless receiver to transmit a beacon for reception by a first user terminal that is associated with the apparatus and also by a second user terminal that is associated with a second apparatus. The controller is further configured to receive feedback from the first user terminal that is associated with the apparatus, the feedback comprising information obtained by the first user terminal from a beacon received from the second apparatus.

Yet another aspect of the exemplary embodiments of this invention provides a method that comprises receiving at a user terminal a first beacon from a first access node that is associated with the user terminal and a second beacon from a second access node that is not associated with the user terminal, where the first and second beacons each comprise information descriptive of radio resources that are used by the access node that transmits the beacon. The method further includes transmitting feedback from the user terminal to the first access node, the feedback comprising at least the information descriptive of the radio resources that are used by the second access node.

Yet another aspect of the exemplary embodiments of this invention provides an apparatus that comprises a controller embodied in a user terminal and configured to operate with a wireless transmitter and a wireless receiver to receive a first beacon from a first access node that is associated with the user terminal and a second beacon from a second access node that is not associated with the user terminal. The first and second beacons each comprise information descriptive of radio resources that are used by the access node that transmits the beacon. The controller is further configured to transmit feedback to the first access node, the feedback comprising at least the information descriptive of the radio resources that are used by the second access node.

### BRIEF DESCRIPTION OF THE DRAWINGS

In the attached Drawing Figures:

FIG. 1 reproduces FIG. 4 of 3GPP TS 36.300, and shows the overall architecture of the EUTRAN system.

FIG. 2 shows a simplified block diagram of various electronic devices that are suitable for use in practicing the exemplary embodiments of this invention.

FIG. 3 is a logic flow diagram that illustrates the operation of a method, and a result of execution of computer program instructions embodied on a computer readable memory, in accordance with the exemplary embodiments of this invention.

FIG. 4 is a logic flow diagram that illustrates the operation of a method, and a result of execution of computer program instructions embodied on a computer readable memory, further in accordance with the exemplary embodiments of this invention.

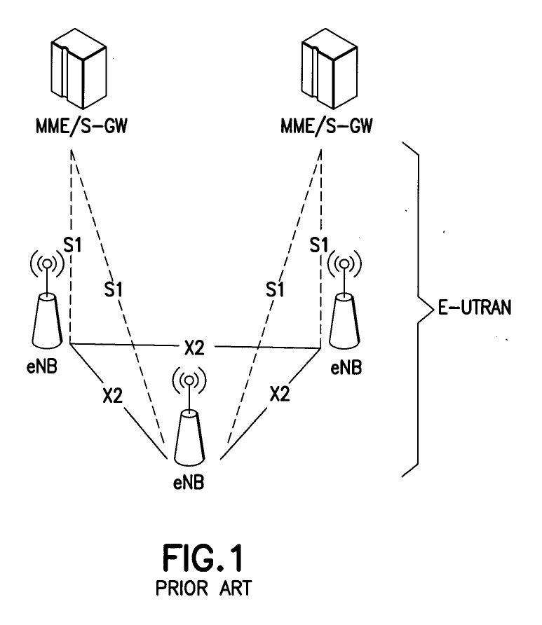

### DETAILED DESCRIPTION

Uncoordinated deployments would benefit significantly from the application of self-organizing flexible spectrum use, in practice providing some degree of automated network optimization for the system.

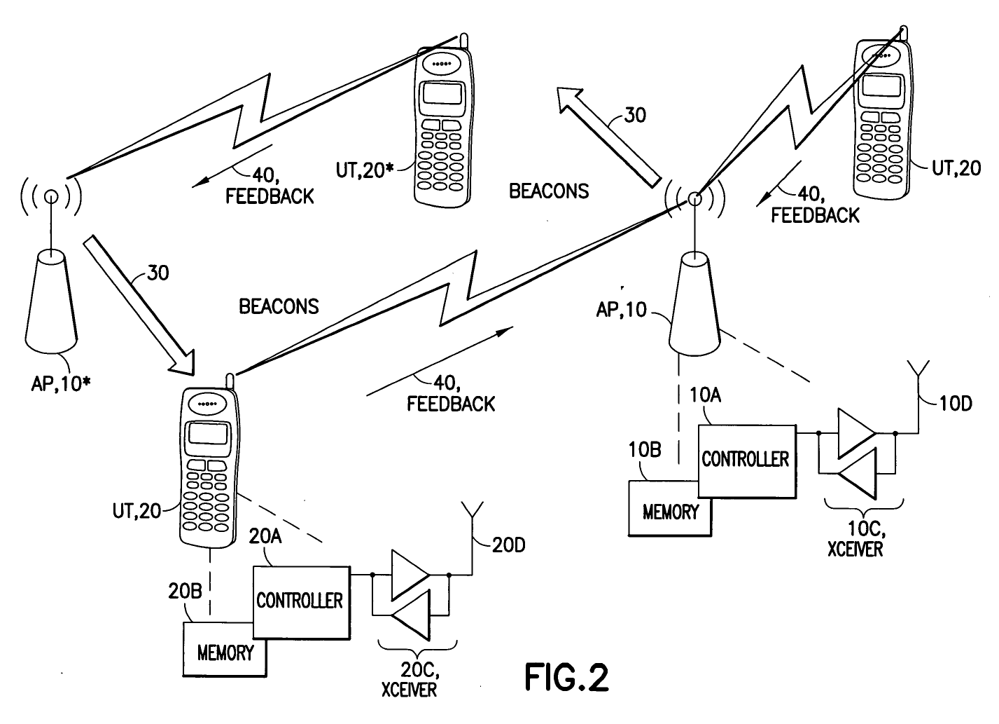

Reference can be made to FIG. 2 which shows a plurality of APs 10 and UTs 20. The APs 10, each of which may also be referred to without a loss of generality as an access node (AN) or as a base station (BS), may be associated with different radio access networks, and may be considered as neighbors, enabling a single UT 20 to receive transmissions from its own AP 10 as well as from a neighboring AP 10. The UTs 20 may also be referred to, without a loss of generality, as mobile nodes (MNs), or as UEs, or as MSs. The AP 10 will generally include at least one controller 10A, such as at least one data processor, possibly a digital signal processor (DSP), at least one memory 10B and at least one radio frequency or other type of wireless transceiver 10C for connection with at least one antenna 10D. The memory 10B, which may be viewed as a computer-readable memory medium, stores in part computer program instructions that when executed enable the AP 10 to function in accordance with the exemplary embodiments of this invention. The UT 20 will also generally include at least one controller 20A, such as at least one data processor, possibly a DSP, at least one memory 20B and at least one radio frequency or other type of wireless transceiver 20C for connection with at least one antenna 20D. The memory 20B, which may also be viewed as a computer-readable memory medium, stores in part computer program instructions that when executed enable the UT 20 to function in accordance with the exemplary embodiments of this invention.

In FIG. 2 the AP 10 is assumed to be associated with a first network, while the AP 10* (and UT 20*) is assumed to be associated with a second, different network. Each AP 10 may be assumed to establish a cell that defines the communication coverage area associated with the AP 10. The cells may be considered in some embodiments to be pico cells or femto cells, i.e., cells having smaller coverage areas than cells associated with conventional cellular communication systems (which may have dimensions measured in kilometers or tens of kilometers).

The exemplary embodiments of this invention utilize in-band broadcast control information that is used to locally monitor the spectrum usage situation. Broadcast messages, also referred to herein as beacons 30, are received by UTs 20 of the same network, as well as by UTs 20 belonging to different, neighboring networks. Each UT 20 further makes and processes measurements to create an understanding of the current spectrum usage situation in the current location of the UT 20. The UT 20 transmits feedback 40 to its own AP 10 in order to create awareness of the spectrum usage over the entire cell.

The transmission of the broadcast control information “in-band” implies that the broadcast control information, referred to herein for convenience as the beacon 30, is transmitted in a same frequency band that is used for transmitting communication data from the access point 10 to the user terminals 20. Note, however, that in other embodiments the beacon 30 could be transmitted out-of-band, i.e., in a frequency band not used for transmitting control data to the user terminals 20.

The exemplary embodiments of this invention provide a method of creating an understanding of the local spectrum usage situation, and thus provide local awareness for the AP 10. The mechanism for creating the local awareness is based on the broadcast control messages, i.e., the beacons 30, which are transmitted by APs 10 and received by UTs 20, and on the resulting feedback 40 from the UTs 20.

The beacons 30 may be used to identify neighbor cells, and which radio resources the neighbor cells are using. The beacons 30 may also be used for estimating how much interference the neighbor cells are causing (how close they are).

As employed herein a radio resource can include, as non-limiting examples, one or more of frequency channels, time slots and/or spreading codes, as well as the use of some resource, such as a frequency channel, for some certain duration, depending on the specifics of the underlying radio access technology.

In order to achieve these goals, a particular beacon 30 includes at least an indication of the resources in use. Note that a particular beacon 30 may also include, as optional information, one or more of the cell identity (which could be received from another channel); and a reference signal for supporting measurements made by the UTs 20 (which may instead be sent via some other mechanism by the system). The reference signal is preferably a known (to the UT 20) type of signal transmitted by the AP 10 that can be used by the UT 20 for at least one of synchronization, detection and/or channel estimation purposes.

Optionally, a beacon 30 may also include information descriptive of bandwidth demand estimates (i.e., an estimated future bandwidth required by the cell (AP 10) to serve the current traffic load of the cell). The estimate may be in the form of more/none/less, as one non-limiting example.

Optionally, a beacon 30 may also include information descriptive of an UL/DL switching point. The use of a flexible UL/DL TDD switching point allows adjusting the balance between UL and DL resources (i.e., what portion of the frames are used for the UL and for the DL). This factor may impact the amount of interference if neighboring cells do not have synchronized and identical frame structures.

Optionally, a beacon 30 may also include information that is related to fairness of resource use amongst the APs 10. The fairness of resource usage may be derived through various signaling mechanisms such as, but not limited to, trading negotiations, auctions and usage history.

Optionally, a beacon 30 may also include information descriptive of any neighbor APs detected by the AP 10. This information refers to the possibility to forward information (related to one or more of the foregoing beacon 30 contents) that is received from neighboring APs 20. This feature enables disseminating the system-related information even further than relying solely on the feedback 40 received from the UTs 20.

A UT 20 receives beacons 30 from one or more neighboring cells (neighboring APs 10) and gathers the information specific to the physical location of the UT 20. The UT 20 then transmits information to the AP 10 that the UT 20 is currently connected to. The beacons 30 received by a UT 20 connected to a particular AP 10, and the resulting information sent as feedback 40 to the AP 10, enable the AP 10 to achieve a collective understanding of the radio resource allocations made by itself for its associated cell, as well as radio resource allocations made by other neighboring APs that affect (or overlap) the cell of the AP 10. The UT 20 feedback 40 reports may contain compressed information of the local situation, such as the available spectrum resources.

The AP 10 operates in part to estimate if the resources currently used by it are sufficient for operation. If the AP 10 finds that it has excess resources, i.e., more resources than are currently necessary to support communications with the UT or UTs 20 within its cell, the AP 10 may release some or all of the excess resources and modify its own beacon 30 accordingly (i.e., to announce that resource(s) released are now free for use by other APs 10). If the current resources of the AP 10 are sufficient, and there are no excess resources available, then no action need be taken. If there is a need for additional resources at the AP 10 then the AP 10 takes action to obtain additional resources.

If the local awareness (obtained from the feedback 40 from UTs 20) indicates that free resources are available, the AP 10 may reserve the resources by modifying resource reservation information in its transmitted beacon 30 to include the new resources. Note that this resource reservation information could be the same as the “resources in use” information discussed above or, alternatively, it could be additional (optional) beacon 30 information that indicates a future intention of the AP 10 with respect to these resources, in addition to the current reservation. Otherwise, the AP 10 waits until resources become available due to a resource release mechanism, or a conflict resolution mechanism may be used to obtain additional resources.

Based on the foregoing it should be appreciated that an aspect of these exemplary embodiments of the invention is providing a local awareness scheme that enables gaining knowledge of the spectrum situation in a local area (a neighborhood), in order to enable self-organizing flexible spectrum use. The local awareness defines which resources are clear to transmit for an AP 10 and which resources are clear for receiving for the AP 10. In addition, the local awareness may contain information of neighboring APs 10 and their future intentions.

The beacons 30 are transmitted only by an AP 10, and the beacon information is received by a UT 20, which then processes and forwards the awareness information to the AP 10.

In general, a beacon frame may be periodically transmitted by an AP 10. Alternatively, the beacon 30 can be embedded into a frame or frames. Separate (possibly dedicated) interference-protected resources may be used for transmission of a beacon 30.

A particular beacon 30 may, in a non-limiting embodiment, contain the cell identification (e.g., using 8 bits) and the resources in use (e.g., using 64 bits). History information may also be present, such as a priority index (e.g., using 6 bits). In addition, a beacon 30 may contain information concerning neighbor APs 10, and possibly a reference signal for synchronization purposes. The AP 10 may also indicate its future intentions, such as by providing a traffic prediction and/or information regarding upcoming resource reservations.

Reference with regard to the priority index may be made to U.S. Provisional Patent Application No. 61/______, filed on even date with this patent application, and entitled “Priority Based Technique to Achieve Fairness for Radio Resource Sharing, Elena Virtej, Jari P. Lundén and Antti S. Sorri, incorporated by reference herein.

One result of using the beacons 30 is that local awareness is gained in the UT 20. This local awareness may include, but is not limited to, neighbor AP 10 detection, occupied channels, interference levels on resources, future intent of neighbor APs 10 and their status and priorities, the TDD frame structure and the UL/DL switching point of neighbor APs 10 (if TDD is used as the radio access technology), as well as the signal strength and channel quality of the associated AP 10.

What may be thus understood at the UT 20 can include, but is not limited to, which resource(s) are available, which resource(s) would be best to use, which resource(s) cannot be used, resource swapping opportunities and/or whether one or more neighbor APs 10 intends to change (reduce or increase) their resource allocations.

Local awareness at the AP 10 can include based on AP 10 measurements, what (UL) resource(s) the AP 10 sees interference on, and can further include the feedback 40 from the UTs 20, own traffic load and where to transmit and schedule the UL.

There are a number of advantages and technical features made possible by the use of these exemplary embodiments.

For example, the use of FSU can greatly improve the spectral efficiency in those situations where deployments are uncoordinated, and traditional frequency planning is not possible or difficult to implement. FSU also enables the network to use higher peak data rates, since instantaneously the UT 20 can have access to a wider spectrum than in a conventional block division of spectrum. In order to make the use of FSU technically feasible, the exemplary embodiments of this invention provide awareness of the spectrum usage situation in a distributed, automated manner.

In general, the exemplary embodiments of this invention may be implemented at least in part by computer software executable by the controllers 10A, 20A, or by hardware, or by a combination of software and hardware (and firmware). The controllers 10A, 20A may be of any type suitable to the local technical environment, and may include one or more of general purpose computers, special purpose computers, microprocessors, digital signal processors (DSPs) and processors based on a multi-core processor architecture, as non-limiting examples. The computer readable memories 10B and 20B may be of any type suitable to the local technical environment and may be implemented using any suitable data storage technology, such as semiconductor based memory devices, flash memory, magnetic memory devices and systems, optical memory devices and systems, fixed memory and removable memory.

In general, the various embodiments of the UT 20 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments may include various integrated circuits and, in a most compact case, may all be embodied physically within a single chip.

Based on the foregoing it should be apparent that the exemplary embodiments of this invention provide a method, apparatus and computer program(s) to enhance local awareness of spectrum usage and other factors of a wireless communication system.

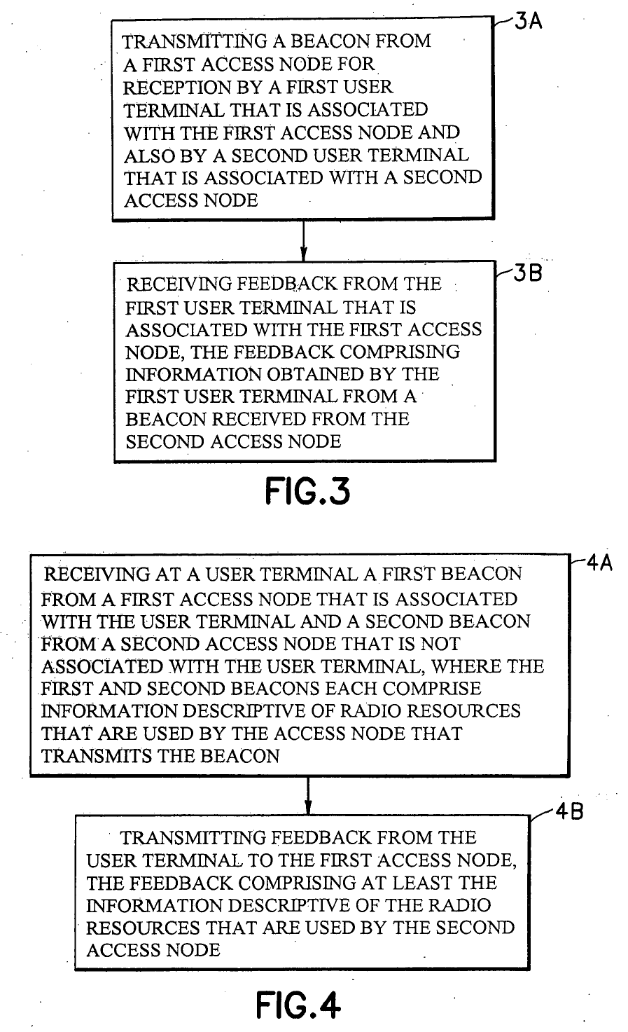

FIG. 3 is a logic flow diagram that illustrates the operation of a method, and a result of execution of computer program instructions, in accordance with the exemplary embodiments of this invention. In accordance with these exemplary embodiments a method performs, at Block 3A, a step of transmitting a beacon from a first access node for reception by a first user terminal that is associated with the first access node and also by a second user terminal that is associated with a second access node. The method further performs, at Block 3B, a step of receiving feedback from the first user terminal that is associated with the first access node, the feedback comprising information obtained by the first user terminal from a beacon received from the second access node.

FIG. 4 is a logic flow diagram that illustrates the operation of a method, and a result of execution of computer program instructions, further in accordance with the exemplary embodiments of this invention. In accordance with these exemplary embodiments a method performs, at Block 4A, a step of receiving at a user terminal a first beacon from a first access node that is associated with the user terminal and a second beacon from a second access node that is not associated with the user terminal, where the first and second beacons each comprise information descriptive of radio resources that are used by the access node that transmits the beacon. The method further includes, at Block 4B, a step of transmitting feedback from the user terminal to the first access node, the feedback comprising at least the information descriptive of the radio resources that are used by the second access node.

The various blocks shown in FIGS. 3 and 4 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above at least partially in the context of the LTE-A system, it should be appreciated that the exemplary embodiments of this invention are not limited for use with only this one particular type of wireless communication system, and that they may be used to advantage in other wireless communication systems. Further, it should be appreciated that the use of this invention may be made in both TDD and FDD type systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
transmitting a beacon from a first access node for reception by a first user terminal that is associated with the first access node and also by a second user terminal that is associated with a second access node; and
receiving feedback from the first user terminal that is associated with the first access node, the feedback comprising information obtained by the first user terminal from a beacon received from the second access node.

2. The method of claim 1, where the beacon comprises an identification of radio resources that are in use.

3. The method of claim 2, where the beacon further comprises an identification of the access node that transmits the beacon.

4. The method as in claim 2, where the beacon further comprises a reference signal for supporting measurements made by the first user terminal.

5. The method as in claim 2, where the beacon further comprises information descriptive of a bandwidth demand estimate.

6. The method as in claim 2, where the beacon further comprises information descriptive of a time division duplex uplink/downlink switching point.

7. The method as in claim 2, where the beacon further comprises information that is related to fairness of resource use amongst a plurality of user terminals.

8. The method as in claim 2, where the beacon further comprises information descriptive of another access node having a transmission that is received by the first access node.

9. The method as in claim 1, further comprising the first access node determining if radio resources currently available to the first access node are sufficient for handling a current communication load and, if the first access node determines that is has excess radio resources, the method further includes releasing some or all of the excess resources and identifying in the beacon the released radio resources.

10. The method as in claim 1, further comprising the first access node determining if radio resources currently available to the first access node are sufficient for handling a current communication load and, if the first access node determines that is has insufficient radio resources, the method further includes reserving additional available radio resources.

11. The method of claim 10, where the first access node becomes aware of the additional available resources from received feedback, and reserves at least some of the available radio resources by including them in a transmitted beacon as part of an identification of radio resources that are in use.

12. The method as in claim 1, where the first access node is associated with a first radio access network, where the second access node is associated with a second radio access network, and where at least one of the first radio access network and the second radio access network employs flexible spectrum usage.

13. The method as in claim 1, where the beacon is transmitted using in-band signaling.

14. A computer-readable memory medium that stores program instructions, the execution of which result in performing operations comprising:
transmitting a beacon from a first access node for reception by a first user terminal that is associated with the first access node and also by a second user terminal that is associated with a second access node; and
receiving feedback from the first user terminal that is associated with the first access node, the feedback comprising information obtained by the first user terminal from a beacon received from the second access node.

15. The computer-readable memory medium of claim 14, where the beacon comprises an identification of radio resources that are in use.

16. The computer-readable memory medium of claim 15, where the beacon further comprises an identification of the access node that transmits the beacon.

17. The computer-readable memory medium as in claim 15, where the beacon further comprises a reference signal for supporting measurements made by the first user terminal.

18. The computer-readable memory medium as in claim 15, where the beacon further comprises information descriptive of a bandwidth demand estimate.

19. The computer-readable memory medium as in claim 15, where the beacon further comprises information descriptive of a time division duplex uplink/downlink switching point.

20. The computer-readable memory medium as in claim 15, where the beacon further comprises information that is related to fairness of resource use amongst a plurality of user terminals.

21. The computer-readable memory medium as in claim 15, where the beacon further comprises information descriptive of another access node having a transmission that is received by the first access node.

22. The computer-readable memory medium as in claim 15, further comprising an operation of the first access node determining if radio resources currently available to the first access node are sufficient for handling a current communication load and, if the first access node determines that is has excess radio resources, the method further includes releasing some or all of the excess resources and identifying in the beacon the released radio resources.

23. The computer-readable memory medium as in claim 15, further comprising the first access node determining if radio resources currently available to the first access node are sufficient for handling a current communication load and, if the first access node determines that is has insufficient radio resources, the method further includes reserving additional available radio resources.

24. The computer-readable memory medium as in claim 23, where the first access node becomes aware of the additional available resources from received feedback, and reserves at least some of the available radio resources by including them in a transmitted beacon as part of an identification of radio resources that are in use.

25. The computer-readable memory medium as in claim 15, where the first access node is associated with a first radio access network, where the second access node is associated with a second radio access network, and where at least one of the first radio access network and the second radio access network employs flexible spectrum usage.

26. The computer-readable memory medium as in claim 15, where the beacon is transmitted using in-band signaling.

27. An apparatus, comprising a controller configured to operate with a wireless transmitter and a wireless receiver to transmit a beacon for reception by a first user terminal that is associated with the apparatus and also by a second user terminal that is associated with a second apparatus, and to receive feedback from the first user terminal that is associated with the apparatus, the feedback comprising information obtained by the first user terminal from a beacon received from the second apparatus.

28. The apparatus of claim 27, where the beacon comprises an identification of radio resources that are in use.

29. The apparatus of claim 28, where the beacon further comprises at least one of an identification of the apparatus that transmits the beacon, a reference signal for supporting measurements made by the first user terminal, information descriptive of a bandwidth demand estimate, information descriptive of a time division duplex uplink/downlink switching point, information that is related to fairness of resource use amongst a plurality of user terminals, information descriptive of another access node having a transmission that is received by the first access node.

30. The apparatus as in claim 27, said controller being further configured to determine if radio resources currently available are sufficient for handling a current communication load and, upon determining that excess radio resources are present, to release some or all of the excess resources and to identify in the beacon the released radio resources, while if it is determined that insufficient radio resources are present, to reserve additional available radio resources.

31. The apparatus of claim 30, where the controller becomes aware of the additional available radio resources from the received feedback, and is further configured to reserve at least some of the available radio resources by including them in a transmitted beacon as part of an identification of radio resources that are in use.

32. The apparatus as in claim 27, where the apparatus is embodied in an access node associated with a first radio access network, where the second apparatus is embodied in an access node associated with a second radio access network, and where at least one of the first radio access network and the second radio access network employs flexible spectrum usage.

33. The apparatus as in claim 27, where the beacon is transmitted using in-band signaling.

34. A method, comprising:
receiving at a user terminal a first beacon from a first access node that is associated with the user terminal and a second beacon from a second access node that is not associated with the user terminal, the first and second beacons each comprising information descriptive of radio resources that are used by the access node that transmits the beacon; and
transmitting feedback from the user terminal to the first access node, the feedback comprising at least the information descriptive of the radio resources that are used by the second access node.

35. The method of claim 34, performed at least in part by execution of computer program instructions by a controller that comprises part of the user terminal.

36. An apparatus, comprising a controller embodied in a user terminal and configured to operate with a wireless transmitter and a wireless receiver to receive a first beacon from a first access node that is associated with the user terminal and a second beacon from a second access node that is not associated with the user terminal, the first and second beacons each comprising information descriptive of radio resources that are used by the access node that transmits the beacon, said controller being further configured to transmit feedback to the first access node, the feedback comprising at least the information descriptive of the radio resources that are used by the second access node.
